(19) United States
(12) Patent Application Publication
(10) Pub. No.: US 2019/0002737 A1
(43) Pub. Date: Jan. 3, 2019

(54) FILM BACKINGS FOR PEEL RELEASE MOUNTING

(71) Applicant: 3M INNOVATIVE PROPERTIES COMPANY, St. Paul, MN (US)

(72) Inventors: Michael B. Runge, Stillwater, MN (US); Gerald S. Deeb, Mendota Heights, MN (US); Brett P. Krull, Minneapolis, MN (US)

(21) Appl. No.: 16/074,651

(22) PCT Filed: Feb. 1, 2017
(86) PCT No.: PCT/US2017/016039

§ 371 Date: Aug. 1, 2018

Related U.S. Application Data
(60) Provisional application No. 62/289,621, filed on Feb. 1, 2016.

(51) Int. Cl. C09J 7/29; B32B 27/08; B32B 27/20; B32B 27/22; B32B 27/32; C09J 7/38; C09J 11/08

(52) U.S. Cl. CPC C09J 7/29; A47G 1/175; B32B 27/20; B32B 27/22; B32B 27/32; C09J 7/387; C09J 11/08; B32B 2307/412; B32B 2405/00; C09J 2205/114; C09J 2205/302; C09J 2453/006; C09J 2423/106; C09J 2423/046; C09J 2423/166; C09J 2433/006; C09J 2493/006; C09J 2453/00; C09J 2409/00; B32B 27/08

(57) ABSTRACT

A peelable adhesive article capable of adhering to a substrate wherein subsequent removal of the adhesive does not damage the substrate, and methods of making and using said peelable adhesive article. The adhesive articles comprise a peelable adhesive adjacent to a major surface of a backing, wherein the backing has a modulus of elasticity and/or modulus of secant between 100 to 18,000 psi as measured by ASTM D638-14 and/or ASTM D412-06a. The backing may be a multilayer backing comprising a core layer and at least one skin layer in a ratio of 2:1 to 100:1.

### TECHNICAL FIELD

The present disclosure generally relates to peelable adhesive articles that are capable of attaching or adhering to a substrate and that can be removed from the substrate without causing damage to the substrate. The present disclosure also generally relates to methods of making and using such adhesive articles.

### BACKGROUND

The revolutionary Command® Adhesive Strip products are a line of stretch removable adhesive strips that holds strongly on a variety of surfaces (including painted drywall, wood, and tile) and that remove cleanly—no holes, marks, or sticky residue. In general, these products include a stretch releasable adhesive composition disposed on tape or other backings. These products generally have utility in bonding to various surfaces or substrates for numerous applications. Stretch releasable adhesive products are designed to firmly adhere an article, such as a hook (to hold a picture or an article of clothing) or other decorative or utilitarian element, to a surface (an adherend), yet remove cleanly when pulled away from the architectural surface at a low angle. The clean removal aspect is so that a tacky and/or unsightly residue is not left behind on the surface after removal of the stretch release adhesive. During the process of stretch release removal, the adhesive layer typically remains adhered to the tape backing as the backing is stretched, but releases from the surface (adherend).

Peelable adhesive technology was recently introduced into products for mounting. Some exemplary commercially available mounting products (e.g., Jimmy Hook™ products, Gecko Tech™ products, Elmer's Freestyle™ products, and Hook Um™ products) rely on suction technology and/or frictional or dry adhesives to generate the mounting device's holding power. The mounting devices include a semi-rigid plastic backing and a rigid hook, both of which are integrated into a one-piece article. The rigid hook is permanently attached to a first major planar surface of the semi-rigid plastic backing. The second major planar surface of the backing can be adhered to a wall surface. The second major planar surface includes one or more of suction technology (e.g., numerous microsuction or nanosuction elements) and/or a frictional adhesive (in which the backing is impregnated with a rubber-based adhesive to increase friction between the substrate and backing) or dry adhesive (which relies on van der Waals forces). The entire construction can, thereafter, be removed by peeling. Additionally, peelable adhesive articles were described in, for example, PCT Patent Publication No. 2015/034104, the entire disclosure of which is incorporated herein.

### SUMMARY

The inventors of the present disclosure sought to make an improved peelable adhesive mounting product. More specifically, the inventors of the present disclosure recognized that the existing commercially available peelable mounting products suffered from various disadvantages. Because of their low adhesiveness, the existing products did not consistently work. Further, they did not work well on various surfaces, including, for example, painted surfaces and rough surfaces (e.g., drywall). Additionally, the existing peelable mounting products have low shear strength and thus can hold little weight or alternatively require a large adhesive surface area. As such, the inventors of the present disclosure sought to formulate peelable mounting products and/or adhesive articles with at least one of higher shear strength, that work well on painted or rough surfaces, and/or that are capable of consistently holding higher weights, all without damaging the substrate to which they are applied.

The present disclosure generally relates to adhesive articles that can be peeled off a substrate without damage. Some embodiments of the adhesive articles include a novel multilayer backing. In some embodiments, the multilayer backing and/or an adhesive article including the multilayer backing is reusable. In some embodiments, the multilayer backing has a modulus low enough to allow sufficient elongation at low force while having a yield point high enough that the force exerted by the peeling action does not significantly permanently deform the backing and/or adhesive article. Some embodiments relate to backing that can reversibly stretch at low forces but that can recover to substantially its original size and/or shape.

Some embodiments relate to a multilayer backing include a core layer between two skin layers. Some embodiments include a polymeric core layer. Some embodiments include polymeric skin layers.

Some embodiments include an adhesive article comprising a multilayer backing comprising a core layer comprising at least one of an elastomeric material, an elastomeric polymer, SEBS, SEPS, SIS, SBS, polyurethane, ethyl vinylacetate (EVA), ethyl methyl acrylate (EMA) ultra low linear density polyethylene (ULLDPE), polypropylene, polypropylene copolymers (including hydrogenated polypropylene copolymers), and combinations or blends thereof; and a first skin layer comprising at least one of polypropylene, polyethylene, high density polyethylene (HDPE), low density polyethylene (LDPE), linear low density polyethylene (LLDPE), a polyurethane, EVA, EMA, and combinations or blends thereof; and a peelable adhesive adjacent to a major surface of the multilayer backing wherein the backing has a core to skin ratio of between about 2:1 and about 100:1 (core:a single skin); and wherein the backing has a modulus of elasticity and/or a modulus of secant of between about 100 psi and about 15,000 psi as determined by at least one of ASTM D638-14 and ASTM D412-06a. Some embodiments further include a second skin layer comprising at least one of polypropylene, polyethylene, high density polyethylene (HDPE), low density polyethylene (LDPE), linear low density polyethylene (LLDPE), a polyurethane, EVA, and combinations or blends thereof.

Some embodiments include an adhesive article wherein the backing has a thickness of between about 4 mils and about 40 mils.

In some embodiments, a force of between about 1N and about 50N per inch width results in at 10% strain in tensile elongation as measured according to ASTM D638-14 and/or ASTM D412-06a.

In some embodiments the core has a tensile and/or elastic modulus of between about 50 psi and about 5000 psi.

In some embodiments, at least one of the first or second skin layer has an elastic and/or secant modulus of between about 3000 psi and about 300,000 psi.

In some embodiments, the core comprises at least one of SEBS, SIS, or SBS.

In some embodiments, the core and/or first or second skin layer further including at least one of a tackifier, a plasticizer, a plasticizing oil, a UV inhibitor, and/or an antioxidant.

In some embodiments, the first skin comprises at least one of polypropylene or polyethylene wherein the second skin comprises at least one of polypropylene or polyethylene.

In some embodiments, the peelable adhesive includes at least one of SBS, SBR, SIS, SEBS, acrylate, and/or polyurethane.

In some embodiments, the peelable adhesive includes at least one of the following tackifiers: polyterpene, terpene phenol, rosin esters, hydrocarbons, C5 resins, C9 resins, and/or rosin acids.

In some embodiments, the peelable adhesive includes at least one of an acrylate, a polyurethane, a tackified rubber adhesives, such as natural rubber; olefins; silicones and silicone block copolymers, such as silicone polyureas; synthetic rubber adhesives such as polyisoprene, polybutadiene, and styrene-isoprene-styrene, styrene-ethylene-butylene-styrene and styrene-butadiene-styrene block copolymers, SBR, SEBS, and other synthetic elastomers; and tackified or untackified acrylic adhesives such as copolymers of isooctylacrylate and acrylic acid, which can be polymerized by radiation, solution, suspension, or emulsion techniques; polyurethanes; and combinations thereof.

In some embodiments the peelable adhesive has a Tg of between about −80 degrees Celsius and about 20 degrees Celsius.

In some embodiments, the backing and/or at least some of the backing layers are substantially optically clear. As used herein, the term “optically clear” means having a light transmission of at least about 50% and/or a haze of no greater than 40%. Some embodiments have a light transmission of at least about 75%. Some embodiments have a haze of no greater than 20%.

### BRIEF DESCRIPTION OF DRAWINGS

FIG. 1 is a schematic drawing of an exemplary multilayer backing as generally described herein.

FIG. 2 is a schematic drawing of the multilayer backing of FIG. 1 in an adhesive article as generally described herein.

FIG. 3 is a schematic drawing of the adhesive article of FIG. 2.

### DETAILED DESCRIPTION

Various embodiments and implementations will be described in detail. These embodiments should not be construed as limiting the scope of the present application in any manner, and changes and modifications may be made without departing from the spirit and scope of the inventions. Further, only some end uses have been discussed herein, but end uses not specifically described herein are included within the scope of the present application. As such, the scope of the present application should be determined by the claims.

In some embodiments, the adhesive articles of the present disclosure can be removed from a substrate or surface without causing damage. As used herein, the term “without causing damage” or “damage-free” or the like means the adhesive article can be separated from the substrate without causing visible damage to paints, coatings, resins, coverings, or the underlying substrate and/or leaving behind residue. Visible damage to the substrates can be in the form of, for example, scratching, tearing, delaminating, breaking, crumbling, straining, and the like to any layers of the substrate. Visible damage can also be discoloration, weakening, changes in gloss, changes in haze, or other changes in appearance of the substrate.

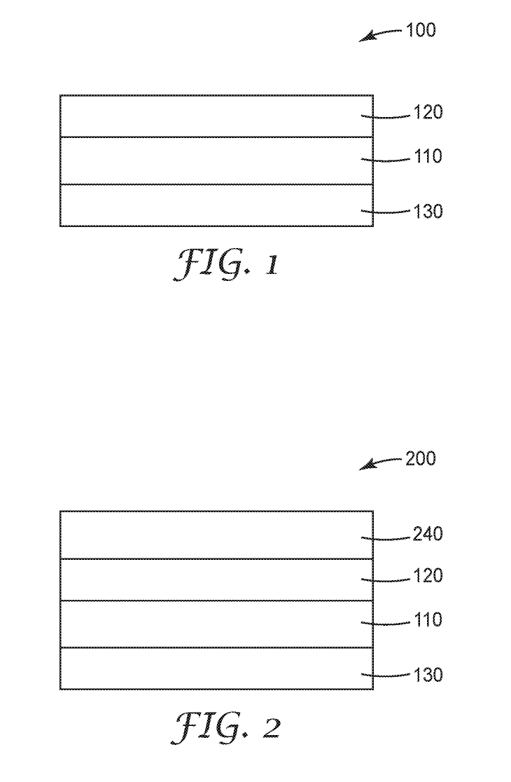

FIG. 1 is a schematic drawing of an exemplary multilayer backing 100 as generally described herein. A multilayer backing can be defined as a backing with two or more layers wherein any individual layer can be a multilayer construction of two or more layers itself. Backing 100 include a core layer 110 between a first skin layer 120 and a second skin layer 130. First and second skin layers 120 and 130, respectively, can the same or different.

The core layer of backing 100 can include at least one of an elastomeric material, a plastomer, an elastomeric polymer, SEBS, SEPS, SIS, SBS, polyurethane, ethyl vinylacetate (EVA), ultra low linear density polyethylene (ULLDPE), hydrogenated polypropylene, and combinations or blends thereof. The core layer of backing 100 can include at least one of an elastomeric material, a plastomer, an elastomeric polymer, SEBS, SEPS, SIS, SBS, polyurethane, ethyl vinylacetate (EVA), ethyl methyl acrylate (EMA) ultra low linear density polyethylene (ULLDPE), hydrogenated polypropylene, and combinations or blends thereof. Suitable, commercially available materials for use in the core layer include: KRATON D1114, a styrene-isoprene-styrene block copolymer (SIS) available from KRATON Corp., Houston, Tex.; EXACT 8201, a metallocene catalyzed ethylene octene alpha olefin copolymer available from Exxon Mobil Corp., Houston, Tex.; KRATON G1657, styrene-ethylene-butylene-styrene block copolymer (SEBS), available from Kraton Performance Polymers; SOLPRENE 1205, a styrene-butadiene rubber (SBR) available from Dynasol Elastomers, Houston, Tex.; and KRATON G1730, a styrene-ethylene-propylene-styrene block copolymer (SEPS), available from KRATON Performance Polymers.

Each of first and second skin layers 120 and 130, respectively, can include at least one of polypropylene, polyethylene, high density polyethylene (HDPE), low density polyethylene (LDPE), linear low density polyethylene (LLDPE), a polyurethane, EVA, ethyl methyl acrylate (EMA) and combinations or blends thereof. Suitable, commercially available materials for use as one or more skin layers include: Optema TC 120, an ethylene methyl acrylate copolymer available from Exxon Mobil; ENGAGE 8450, an ethylene-octene copolymer, available from Dow Chemical Inc., Midland, Mich.; AFFINITY PL 1850G plastomer, an ethylene-octene copolymer available from Dow Chemical; PP1024, a polypropylene homopolymer available from Exxon Mobil.

In some embodiments, one or both skin layers 120, 130 are more or less elastic than the core layer. In some embodiments, at least one of the core and skin layer(s) include a foam. In other embodiments, neither the core nor skin layers include a foam, such that the backing does not include deliberate voids created in the volume of the constituent films.

In some embodiments, the backing has a modulus of elasticity and/or a modulus of secant of between about 100 psi and about 18,000 psi as determined by at least one of ASTM D638-14 and ASTM D412-06a. In some embodiments, the backing has a module of elasticity and/or a modulus of secant of at least about 200 psi, at least about 400 psi, at least about 600 psi, at least about 1000 psi, at least about 1500 psi, at least about 2500 psi, at least about 3500 psi as determined by at least one of ASTM D638-14 and ASTM D412-06a. In the same or different embodiments, the backing has a modulus of elasticity and/or a modulus of secant of no greater than about 17,000 psi, no greater than about 15,000 psi, of no greater than about 13,000 psi, of no greater than 12,000 PSI, and of no greater than 10,000 psi as determined by at least one of ASTM D638-14 and ASTM D412-06a.

In some embodiments, the backing exhibits an elastic recovery of 1-100% at 10% strain as measured by ASTM D5459-95. In some embodiments, the backing exhibits an elastic recovery of 1-100% at 20% strain.

In some embodiments, a force of no greater than about 20N/in is registered by the backing at 50% strain as measured according to ASTM D638-14 and/or ASTM D412-06a. In some embodiments, a force of no greater than about 15N/in is registered at 50% strain as measured according to ASTM D638-14 and/or ASTM D412-06a. In some embodiments, a force of between about 0.5N and about 10N per inch is registered at 50% strain as measured according to ASTM D638-14 and/or ASTM D412-06a.

In some embodiments, the backing can demonstrate a strain at yield (ϵ₀) (i.e., the strain at the elastic limit or at the onset of plastic deformation) of no greater than about 15%. In other embodiment, the strain at yield is not great than about 12%, or not greater than about 10%.

In some embodiments, the multilayer backing has a core to skin ratio of between about 2:1 and about 300:1 where the ratio represents the thickness of a single core layer to a single skin layer. The ratios depend highly on the multilayer materials as well as the overall thickness of the multilayer film. In one exemplary embodiment, based on a multilayer film composed of a Kraton 1657 core and Engage 8450 skin layers with a total thickness ranging between 6-14 mils, the preferred core/skin ratio would be about 6:1 to about 20:1.

The core to skin ratio of the backings of the present disclosure is typically greater in embodiments featuring a foamed core as described herein. Such embodiments can include core/skin ratios of no greater than about 300:1, no greater than about 200:1, no greater than about 150:1; or no greater than about 100:1. In embodiments featuring a core that is not foamed (i.e., one that does not include deliberate voids), the core to skin ratio is typically no greater than about 100:1, and in presently preferred circumstances no greater than about 75:1 or no greater than about 50:1.

By changing the ratios of core to skin, both the thickness of the core and skin, as well as their elastic properties, may be varied. In particular, the non-recoverable strain (e.g., plastic deformation) can be reduced in some embodiments by increasing the core to skin ratio (or increased by decreasing the same ratio). This allows for same backing materials to be used in various combinations with selectable impact on the resulting adhesive article. An ability to change the non-recoverable strain in the multilayer backing can allow one to deliberately design, for example, both the release force and the maximum load of an adhesive article. In some embodiments, the backing can non-recoverable strain of no greater than about 20%. In other embodiment, the strain at yield is not great than about 15%, or not greater than about 10%.

In some embodiments, multilayer backings consist of an A/B/A configuration where A represents skin layers and B represents a core layer. In some embodiments, multilayer backings consist of A/B/C configuration where A consists of a skin layer, B consists of a core layer, and C consists of a skin layer of composition different from A.

A backing including a core layer and one or more skin layers can have these layers bonded to one another using any suitable mechanism including, for example, coextruding the core and the skin layer(s), co-molding, extrusion coating, joining through an adhesive composition, joining under pressure, joining under heat, and combinations thereof.

In some embodiments, the backing has a thickness of between about 2 mils and about 40 mils. In some embodiments, the backing has a thickness of greater than 2 mils, greater than 5 mils, greater than 8 mils, greater than 10 mils, greater than 12 mils, greater than 15 mils, greater than 20 mils, greater than 22 mils, or greater than 24 mils. In some embodiments, the backing has a thickness of less than 40 mils, less than 38 mils, less than 35 mils, less than 32 mils, less than 30 mils, less than 28 mils, or less than 25 mils.

In some embodiments, the backing has a modulus ranging between 100 psi and 18000 psi, and in some embodiment the backing has a moduls ranging from 100 psi to 15000 psi. In some embodiments the modulus is greater than 100 psi, greater than 500 psi, greater than 1000 psi. In some embodiments the backing modulus is less than 15000 psi, less than 10000 psi, less than 8,000 psi, less than 5,000 psi, less than 3,500 psi, less than 2000 psi, and less than 1500 psi.

The adhesive article or backing can include a non-tacky tab, which can be grasped and pulled by a user to stretch and/or peel the tape during the removal process, so as to remove the tape from the object or substrate to which it has been affixed. The non-tacky tab can be an extension of the backing material or a detackified portion of the adhesive. The non-tacky tab can be formed from a tacky adhesive substrate using any known method of producing a non-tacky area including, e.g., applying a detackifying or deadening material or process to the adhesive to render it non-tacky.

The adhesive article can also include one or more liners disposed on the exposed surface(s) of the adhesive composition to protect the adhesive until use. Examples of suitable liners include paper, e.g., kraft paper, or polymeric films, e.g., polyethylene, polypropylene or polyester. At least one surface of the liner can be treated with a release agent such as silicone, a fluorochemical, or other low surface energy based release material to provide a release liner. Suitable release liners and methods for treating liners are described in, e.g., U.S. Pat. Nos. 4,472,480, 4,980,443 and 4,736,048, and incorporated herein. Preferred release liners are fluoroalkyl silicone polycoated paper. The release liner can be printed with lines, brand indicia, or other information.

Some embodiments include dyes or pigments that color at least some or all of the backing layers.

Some embodiments include dyes or pigments that color at least some or all of the backing layers. Some embodiments include at least one tackifier in at least one layer of the backing. Suitable tackifiers include a rosin, a rosin derivative, a terpene resin, a phenolic resin, a petroleum-based resin, or a combination thereof. In some embodiments, the tackifier is a terpene phenol. Inclusion of a tackifier the one or more of the backing layers can inhibit migration of the adhesive layer or components thereof into the backing.

In certain embodiments, the backing consists of a single layer otherwise meeting the modulus, thickness, and other parameters of the multilayer backings described above. In some embodiments, the single layer film is an isotactic proproylene with random ethylene distribution, available, for example, as VISTAMAXX 3980FL or VISTAMAXX 6102 from ExxonMobil Chemical Company, Spring, Tex. Such films can also be used as the core or one or more skin layers.

Adhesive Articles

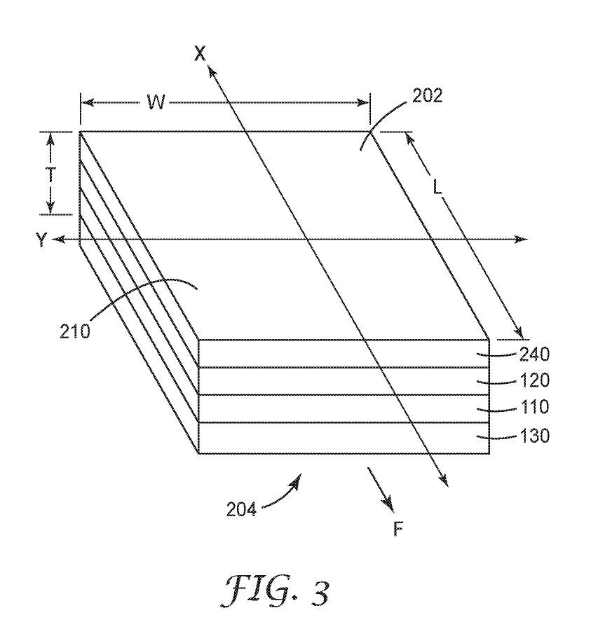

FIGS. 2 and 3 are schematic drawing of an exemplary adhesive article 200 as generally described herein. Adhesive article 200 includes backing 100, including a core layer 110 between a first skin layer 120 and a second skin layer 130, and a peelable adhesive layer 240 adjacent to first skin layer 120. In some embodiments, a second peelable adhesive layer (not shown) is adjacent to second skin layer 130. The adhesive article includes having first and second opposed major surfaces 202, 204, a thickness “T”, a first major axis X defined by the direction of a stretch force F applied to the article during the stretch release process, a length “L” defined along the first major axis X, a second major axis Y transverse to the first major axis X, and a width “W” defined along the second major axis Y. The first major surfaces 202 includes an adhesive region 210. In some embodiments, a second adhesive layer (not shown) can be disposed adjacent to second skin layer 130, such that the second major surface 204 also includes an adhesive region.

An available adhesive area on the first major surface 202 is defined by the length “L” and width “W” of the adhesive region 210 (here coextensive with the first major surface 202). Adhesive articles further include a given width W to thickness T ratio as measured in an imaginary plane normal to the first major axis X. The available adhesive area can be at least about 10 square centimeters (cm²), at least about 50 cm², at least about 100 cm², or at least about 150 cm². Depending on the particular end use application, the adhesive regions may provide larger available adhesive areas.

The peelable adhesive can include any peelable adhesive having the desired properties. The adhesive can be, for example, any of the adhesives described in any of the following patent applications, all of which are incorporated by reference herein: PCT Patent Publication Nos. 2015/035556, 2015/035960, U.S. Patent Application No. 2015/034104, or pending patent application matter numbers (assigned to the present assignee): 62/439576, 62/289660, or 62/289673, all of which are incorporated herein in their entirety.

In some embodiments, the peelable adhesive is a pressure sensitive adhesive. A general description of useful pressure-sensitive adhesives may be found in the Encyclopedia of Polymer Science and Engineering, Vol. 13, Wiley-Interscience Publishers (New York, 1988). Additional description of useful pressure-sensitive adhesives may be found in the Encyclopedia of Polymer Science and Technology, Vol. 1, Interscience Publishers (New York, 1964). Any suitable composition, material or ingredient can be used in the pressure-sensitive adhesive. Exemplary pressure-sensitive adhesives utilize one or more thermoplastic elastomers, e.g., in combination with one or more tackifying resins.

In some embodiments, the peelable adhesive layer can include at least one of rubber, silicone, or acrylic based adhesives. In some embodiments, the peelable adhesive layer can include a pressure-sensitive adhesive (PSA) or an epoxy adhesive. In some embodiments, the peelable adhesive can include tackified rubber adhesives, such as natural rubber; olefins; silicones, such as silicone polyureas; synthetic rubber adhesives such as polyisoprene, polybutadiene, and styrene-isoprene-styrene, styrene-ethylene-butylene-styrene and styrene-butadiene-styrene block copolymers, and other synthetic elastomers; and tackified or untackified acrylic adhesives such as copolymers of isooctylacrylate and acrylic acid, which can be polymerized by radiation, solution, suspension, or emulsion techniques; polyurethanes; silicone block copolymers; and combinations of the above. The adhesive can be, for example, any of the adhesives described in any of the following patent applications, all of which are incorporated by reference herein: PCT Patent Publication Nos. 2015/035556, 2015/035960, and US 2015/034104.

In some embodiments, the adhesive includes a tackifier. Some exemplary tackifiers include at least one of polyterpene, terpene phenol, rosin esters, and/or rosin acids.

In some embodiments, the peelable adhesive is a flowable adhesive that can be coated onto the backing. In some embodiments, the peelable adhesive is a more solid adhesive as is generally described in, for example, German Patent No. 33 31 016.

In some embodiments, adhesion properties of the adhesive can range from 0 N/dm to 25 N/dm. In some embodiments, adhesion properties of the adhesive can range from 0.5 N/dm to 10 N/dm. In some embodiments, adhesion properties of the adhesive can range from 1 N/dm to 5 N/dm.

In some embodiments, the peelable adhesive can provide a shear force of, for example, 4-20 pounds per square inch.

In some embodiments, the adhesive article can be peeled from at least one of the second terminal end, the first side, or the second side. In some embodiments, the adhesive article can be peeled from at least two of the second terminal end, the first side, or the second side.

In some embodiments, the peelable adhesives are tailored to achieve peel with no or minimal damage. Exemplary methods and articles for doing so are described in, for example, U.S. Pat. No. 6,835,452 and provisional patent applications filed by the present assignee under the following application numbers: 62/289660, and 62/379812, all of which are incorporated herein in their entirety.

In some embodiments, the peelable adhesive has a Tg of between about −80 degrees Celsius and about 20 degrees Celsius. In some embodiments, the peelable adhesive has a Tg of between about −70 degrees Celsius and about 0 degrees Celsius. In some embodiments, the peelable adhesive has a Tg of between about −60 degrees Celsius and about −20 degrees Celsius. In some embodiments, the peelable adhesive has a Tg of greater than −80 degrees Celsius, greater than −70 degrees Celsius, greater than −60 degrees Celsius, greater than −50 degrees Celsius, greater than −40 degrees Celsius, or great than −30 degrees Celsius. In some embodiments, the peelable adhesive has a Tg of less than 20 degrees Celsius, 10 degrees Celsius, 0 degrees Celsius, −10 degrees Celsius, −20 degrees Celsius, or −30 degrees Celsius.

In some embodiments, the peelable adhesive has a storage modulus at 25° C. ranging from 300,000 Pa to 5,000,000 Pa. In other embodiments, the storage modulus at 25° C. ranges from about 500,000 to about 4,000,000 Pa. In some embodiments, the storage modulus at 25° C. is at least 300,000 Pa, at least 500,000 Pa, at least 750,000 Pa, and at least 1,000,000 Pa. In the same or different embodiments, the storage modulus at 25° C. is no greater than about 5,000,000 Pa, no greater than about 4,500,000 Pa, no greater than about 4,000,000 Pa, no greater than about 3,000,000 Pa, and/or no greater than about 2,500,000 Pa.

In some embodiments, the adhesive article exhibits an elastic recovery of greater than 70% or greater than 80% or greater than 95% at 10% strain. In some embodiments, the adhesive article exhibits an elastic recovery of greater than 70% or greater than 80% or greater than 90% at 25% strain. In some embodiments, the adhesive article exhibits an elastic recovery of greater than 70% or greater than 80% or greater than 90% or greater than 95% at 50% strain. In some embodiments, the adhesive article exhibits an elastic recovery of greater than 50% or greater than 70% or greater than 95% at 100% strain.

In some embodiments, the backing can prevent or minimize substrate damage by lowering the peel force through elongation of the backing which aids in adhesive removal. In some embodiments this can occur at peel angles ranging from 0-180 degrees. In some embodiments, when the final tape construction is peeled from the adherend at 90-180 degrees the backing elongates less than 1% during peeling. In some embodiments, when the final tape construction is peeled from the adherend at 90-180 degrees the backing elongates less than 5% during peeling. In some embodiments, when the final tape construction is peeled from the adherend at 90-180 degrees the backing elongates less than 10% during peeling. In some embodiments, when the final tape construction is peel from an adherend at 90-180 degrees the backing elongates more than 10% strain, and elastically recovers more 80% of that deformation. In some embodiments, when the final tape construction is peel from an adherend at 90-180 degrees the backing elongates more than 10% strain, and elastically recovers more 90% of that deformation. In some embodiments, when the final tape construction is peel from an adherend at 90-180 degrees the backing elongates more than 10% strain, and elastically recovers more 95% of that deformation. In some embodiments, when the final tape construction is peel from an adherend at 90-180 degrees the backing elongates more than 10% strain, and elastically recovers more 99% of that deformation.

In some embodiments, the backing and/or at least some of the backing layers are substantially optically clear. As used herein, the term “optically clear” means having a light transmission of at least about 50% and/or a haze of no greater than 40%. Some embodiments have a light transmission of at least about 75%. Some embodiments, have a haze of no greater than 20%. Both the light transmission and the haze of the carrier (or at least some of the layers thereof) can be determined using, for example, ASTM D1003-95.

In some embodiments, the adhesive article has a thickness that is between about 2 mil and about 40 mils. In some embodiments, the thickness is greater than 3 mil, greater than 4 mil, greater than 5 mils, greater than 8 mils, greater than 10 mils, greater than 12 mils, greater than 15 mils, or greater than 20 mils. In some embodiments, the thickness is less than 40 mils, less than 38 mils, less than 35 mils, less than 33 mils, less than 30 mils, less than 28 mils, less than 25 mils, less than 22 mils, or less than 20 mils.

In some embodiments, the peel force is below 30 oz/inch at all points along the adhesive article.

In some embodiments, a force of between about 1N and about 50N per inch width is required to strain the adhesive article 10% in tensile elongation as measured according to ASTM D638-14 and/or ASTM D412-06a. In some embodiments, a force of between about 2N and about 30N per inch width is required to strain the adhesive article 10% in tensile elongation as measured according to ASTM D638-14 and/or ASTM D412-06a. In some embodiments, a force of between about 3N and about 15N per inch width is required to strain the adhesive article 10% in tensile elongation as measured according to ASTM D638-14 and/or ASTM D412-06a.

Some embodiments further include a mounting device. Exemplary mounting devices include, for example, hooks, clips, and loops. Any of the following mounting devices can be used with the adhesive article of the present disclosure: Application Matter No. 77486US002 (assigned to the present assignee), U.S. Pat. No. 5,409,189 (Luhmann), U.S. Pat. No. 5,989,708 (Kreckel), U.S. Pat. No. 8,708,305 (McGreevy), U.S. Pat. No. 5,507,464 (Hamerski et al.), U.S. Pat. No. 5,967,474 (doCanto et al.), U.S. Pat. No. 6,082,686 (Schumann), U.S. Pat. No. 6,131,864 (Schumann), U.S. Pat. No. 6,811,126 (Johansson, et al.), U.S. Pat. No. D665,653, and U.S. Pat. No. 7,028,958 (Pitzen, et al.), all of which are incorporated by reference in their entirety herein.

In some embodiments, the adhesive article has an elongation at break of at least 400%.

In some embodiments, the adhesive article can further include a separable connector. Some exemplary separable connectors are described in, for example, U.S. Pat. Nos. 6,572,945; 7,781,056; 6,403,206; and 6,972,141, all of which are incorporated by reference in their entirety herein.

Methods of Making the Adhesive Articles

The adhesive articles described herein can be made in various ways. In some embodiments, the peelable adhesive can be directly coated onto a major surface of the backing. In other embodiments, the peelable adhesive can be formed as a separate layer (e.g., coated onto a release liner) and then laminated to the backing.

The peelable adhesive can be prepared using a variety of common methods for preparing adhesives. For example, the peelable adhesive composition can be coated onto a release liner, coated directly onto a backing, or formed as a separate layer (e.g., coated onto a release liner) and then laminated to a backing.

To improve adhesion of the adhesive composition to the backing, the backing can be pretreated prior to applying, e.g., coating or laminating, the adhesive composition on the backing. Examples of suitable treatments include corona discharge, plasma discharge, flame treatment, electron beam irradiation, ultraviolet (UV) radiation, acid etching, chemical priming and combinations thereof. The treatment can optionally be performed with a reactive chemical adhesion promoter including, e.g., hydroxyethylacrylate, or hydroxyethyl methacrylate, or another reactive species of low molecular weight.

In some embodiments, one or more of the backing or adhesive layers can be foamed, as is described herein.

Methods of Using the Adhesive Articles

The adhesive articles of the present disclosure can be used in various ways. In some embodiments, the adhesive article is applied, attached to, or pressed into an adherend. In this way, the adhesive article contacts the adherend. Where a release liner is present, the release liner is removed before the adhesive article is applied, attached to, or pressed into an adherend. In some embodiments, at least a portion of the adherend is wiped with alcohol before the adhesive article is applied, attached to, or pressed into an adherend.

Removing the adhesive article from an adherend can be carried out by peeling the tape at a peel angle. In some embodiments, the peel angle is, for example, 90° or higher. In some embodiments, the peel angle can be lower than 90°. Removal at the appropriate peel angle can result in leaving no substantial or appreciable adhesive residue and in preventing the surface of the substrate from being damaged.

The following examples describe some exemplary constructions of various embodiments of the adhesive articles and methods of making the adhesive articles described in the present application. The following examples describe some exemplary constructions and methods of constructing various embodiments within the scope of the present application. The following examples are intended to be illustrative, but are not intended to limit the scope of the present application.

### EXAMPLES

TABLE 1
Material and supplier information

| Material | Description | Supplier |
|---|---|---|
| KRATON G1657 | Linear triblock copolymer based | KRATON Corp., Houston, TX |
| | on styrene and | |
| | ethylene/butylene (SEBS) with a | |
| | polystyrene content of 13% | |
| KRATON G1730 | Copolymer based on styrene and | KRATON Corp., Houston, TX |
| | ethylene/propylene (SEPS) with | |
| | a polystyrene content of 21% | |
| KRATON D1114 | Linear triblock copolymer based | KRATON Corp., Houston, TX |
| | on styrene and isoprene (SIS) | |
| | with a polystyrene content of | |
| | 19% | |
| KRATON 1106 | Linear triblock copolymer based | KRATON Corp., Houston, TX |
| | on styrene and isoprene (SIS) | |
| | with polystyrene content of | |
| | 15%, and diblock (SI) content of | |
| | 17% | |
| VISTAMAXX 6102 | Polymer primarily of isotactic | ExxonMobil Corp., Houston, |
| | propylene with random ethylene | TX |
| | distribution (16 wt % ethylene) | |
| VISTAMAXX 3980 | Polymer primarily of isotactic | ExxonMobil Corp., Houston, |
| | propylene with random ethylene | TX |
| | distribution (8 wt % ethylene) | |
| OPTEMA TC120 | Ethylene methyl acrylate | ExxonMobil Corp., Houston, |
| | copolymer | TX |
| PP1024 | Polypropylene homopolymer | ExxonMobil Corp., Houston, TX |
| PP3445 | Polypropylene homopolymer | Exxon Mobil Corp., Houston, |
| | | TX |
| ENGAGE 8450 Polyolefin | Ethylene-Octene Copolymer | Dow Chemical Co., Midland MI |
| Elastomer | | |
| ENGAGE 8200 Polyolefin | Ethylene-Octene Copolymer | Dow Chemical Co., Midland, |
| Elastomer | | MI |
| AFFINITY PL 1850G | Ethylene-Octene Copolymer | Dow Chemical Co., Midland MI |
| Polyolefin Plastomer | | |
| KRATON D1184 | Radial Styrene-Butadiene Block | KRATON Corp., Houston, TX |
| | Copolymer (SBS) | |
| SOLPRENE 1205 | Styrene-Butadiene Rubber | Dynasol Elastomers, Houston, |
| | (SBR) | TX |
| PINOVA PICCOLYTE A135 | Polyterpene resin | Pinova Inc., Brunswick, GA |
| (PA 135) | | |
| POLYSTER T130 (YS T130) | Terpene phenolic resin | Yasuhara Chemical Company, |
| | | Ltd., Fuchu-city, Hiroshima, |
| | | Japan |
| VOLTEK Type E0 | Polyethylene vinyl acetate | Voltek, Division of Sekisui |
| | copolymer foam | America Corporation of |
| | | Lawrence, MA |
| EXACT 8201 | Metallocene catalyzed ethylene | ExxonMobil Corp., Houston, |
| | octene alpha olefin copolymer | TX |
| POLYSTER T160 (YS T160) | Terpene phenolic resin | Yasuhara Chemical Company, |
| | | Ltd., Fuchu-city, Hiroshima, |
| | | Japan |

Test Methods

90° Peel Adhesion Strength Test

The peel adhesion strength and removability were evaluated by the following method. Test strips were applied to adherends by rolling down with a 15 lb. roller. Adhered samples were aged at 72° F. (22° C.). 50% relative humidity for 7 days before testing, except for samples 19-24 had a dwell time of 1 day. The strips were peeled from the panel using an INSTRON universal testing machine with a crosshead speed of 12 in/min (30.5 cm/min). The peel force was measured and the panels were observed to see if visible adhesive residue remained on the panel or damage occurred. A rating of 0 was the best rating, indicating essentially no adhesive residue remained on the panel or damage occurred. A rating of 5 was the worst rating, indicating the most adhesive transfer or damage occurred. The Damage Ranking was as follows: 0-no damage, 1-small paint bubble (less than 10% of surface area), 2-large paint bubble (great than 10% of surface area), 3-small paper tear, 4-Paper tear/damage (<50%), 5-Paper tear damage (>50%). Two replicates were tested for each sample.

Tensile Test

The tensile test and the mechanical values listed below are modified from ASTM D638-14 and ASTM D412-06a.

The multilayer backings were cut using a razor into strips having a width of 1 in (2.54 cm) and a length of at least 6 in (15.2 cm). The strips were loaded onto an INSTRON (Norwood, Mass.) 5944 load frame with 225 lbs load cell and 1KN pneumatic clamps (PN 2712-041) with a gauge length of 4 in (10.2 cm). Samples were pulled in tension at a strain rate of 1* min⁻¹ (crosshead speed of 4 inches per minute for the 4-inch gauge length) to a displacement of 16 inches (40.6 cm or 400% Strain) and subsequently unloaded at the same strain rate to the original gauge length. Load-Extension was collected and output by the INSTRON machine and converted to stress-strain by normalizing Force per Unit Cross-Section Area (σ=_{A}^{/F}).

Determination of Modulus of Elasticity

The modulus of Elasticity was calculated from the tensile data collected using the procedure above as the slope (ratio of stress to strain) of the stress-strain curve in the linear-elastic region.

Determination of Secant Modulus

The secant modulus was calculated from the tensile data collected using the procedure above as the slope (ratio of stress to strain) of a line drawn from the origin of the stress-strain curve to the point on stress-strain curve where 2% strain is attained.

Determination of Yield Stress and Strain at Yield

The Yield Stress and Strain at Yield were determined from tensile data collected as described previously. The Yield Point (Stress and Strain where yield occurs) was determined using a 2% Strain Offset.

Determination of P50

The P50 value is the load (Force) attained at 50% strain determined from the tensile data collected as described above.

Test Adherends

Drywall panels (obtained from Materials Company, Metzger Building, St. Paul, Minn.) were painted Sherwin-Williams DURATION Interior Acrylic Latex Ben Bone White Paint (Sherwin-Williams Company, Cleveland, Ohio).

Procedure for painting: a first coat of paint was applied to a panel by paint roller, followed by air drying for 24 hours at ambient conditions. A second coat of paint was applied and dried at ambient conditions for at least 7 days at ambient conditions before use.

### Examples 1-24

Preparation of Multilayer Films

Multilayer film backings were prepared by coextruding a sheet of elastomeric core material together with two skin layers, one on either side of the elastomeric core layer, using a continuous coextrusion process like that described for Example 3 in U.S. Pat. No. 5,501,679. Details of the multilayer film constructions are provided in Table 2. Example 18 represents a construction where a 2 weight % of a foaming agent (SAFOAM® RIC-50FP, Reedy Chemical Foam, Charlotte, N.C.) was added to the core layer. The multilayer film constructions are summarized in Table 2.

The film backing of Example 24 was an 81 μm thick, single layer, extruded film of VISTAMAX 6102.

TABLE 2
Multilayer Film Constructions

| | | | Core Layer | Skin Layer | Core Layer to | Total Film |
|---|---|---|---|---|---|---|
| | Core Layer | Skin Layer | Thickness | Thickness | Skin Layer | Thickness |
| Example | Material | Material | (μm) | (μm) | Ratio | (μm) |
| 1 | KRATON | PP1024 | 79 | 8 | 10/1 | 95 |
| | 1730 | | | | | |
| 2 | KRATON | ENGAGE | 204 | 24 | 9/1 | 252 |
| | 1657 | 8450 | | | | |
| 3 | KRATON | ENGAGE | 174 | 9 | 19/1 | 192 |
| | 1657 | 8450 | | | | |
| 4 | KRATON | PP1024 | 75 | 8 | 9/1 | 91 |
| | 1730 | | | | | |
| 5 | KRATON | AFFINITY | 131 | 10 | 13/1 | 151 |
| | 1657 | 1850 | | | | |
| 6 | KRATON | AFFINITY | 155 | 9 | 15/1 | 173 |
| | 1657 | 1850 | | | | |
| 7 | KRATON | AFFINITY | 121 | 6 | 20/1 | 133 |
| | 1657 | 1850 | | | | |
| 8 | KRATON | AFFINITY | 131 | 5.5 | 24/1 | 142 |
| | 1657 | 1850 | | | | |
| 9 | KRATON | ENGAGE | 70 | 10 | 7/1 | 90 |
| | 1114 | 8450 | | | | |
| 10 | KRATON | ENGAGE | 109 | 16 | 7/1 | 141 |
| | 1114 | 8450 | | | | |
| 11 | KRATON | AFFINITY | 101 | 13 | 8/1 | 127 |
| | 1114 | 1850 | | | | |
| 12 | KRATON | AFFINITY | 228 | 12 | 19/1 | 252 |
| | 1114 | 1850 | | | | |
| 13 | KRATON | ENGAGE | 429 | 39 | 11/1 | 507 |
| | 1657 | 8450 | | | | |
| 14 | KRATON | ENGAGE | 125 | 11 | 11/1 | 147 |
| | 1657 | 8450 | | | | |
| 15 | KRATON | ENGAGE | 93 | 4 | 23/1 | 101 |
| | 1657 | 8450 | | | | |
| 16 | KRATON | ENGAGE | 464 | 17 | 27/1 | 499 |
| | 1657 | 8450 | | | | |
| 17 | KRATON | ENGAGE | 144 | 9 | 16/1 | 162 |
| | 1657 | 8450 | | | | |
| 18 | KRATON | ENGAGE | N/A (Foam) | N/A (Foam) | N/A (Foam) | 725 |
| | 1657 | 8450 | | | | |
| 19 | KRATON | VISTAMAXX | 136 | 3 | 45/1 | 142 |
| | 1114 | 3980 | | | | |
| 20 | KRATON | OPTEMA | 120 | 10 | 12/1 | 140 |
| | 1114 | TC120 | | | | |
| 21 | KRATON | OPTEMA | 109 | 18 | 6/1 | 145 |
| | 1114 | TC120 | | | | |
| 22 | KRATON | ENGAGE | 88 | 2 | 44/1 | 92 |
| | 1106 | 8200 | | | | |
| 23 | KRATON | AFFINITY | 109 | 8 | 14/1 | 125 |
| | 1114/ | 1850 | | | | |
| | POLYSTER | | | | | |
| | T160 (70 PPH) | | | | | |
| Control | VOLTEK E0 | EXACT | 124 | 7 | 18/1 | 138 |
| | | 8201 | | | | |

Pressure Sensitive Adhesive Formulations

The pressure-sensitive adhesive formulation for Examples 1-18 and the Control was prepared having an 85:15 ratio of KRATON D1184 to SOLPRENE 1205 as the elastomer component and 45 parts of total tackifier component based on 100 parts of total elastomer. The tackifier component had an 80:20 ratio of PICCOLYTE A135 to POLYSTER T130. All of the components were added to a glass jar along with toluene to make a solution of approximately 43% solids. The jar was sealed and the contents thoroughly mixed by placing the jar on a roller at about 2-6 rpm for at least 24 hours prior to coating. The pressure sensitive adhesive formulation for Examples 19-24 was prepared having an 85:15 ratio of KRATON D1184 to SOLPRENE 1205 as the elastomer component and 37.5 parts of total tackifier component based on 100 parts of total elastomer. The tackifier component had a 39:1 ratio of PICCOLYTE A135 to POLYSTER T130. All of the components were added to a glass jar along with toluene to make a solution of approximately 43% solids. The jar was sealed and the contents thoroughly mixed by placing the jar on a roller at about 2-6 rpm for at least 24 hours prior to coating.

The pressure sensitive adhesive formulation for Examples 19-24 was prepared having an 85:15 ratio of KRATON D1184 to SOLPRENE 1205 as the elastomer component and 37.5 parts of total tackifier component based on 100 parts of total elastomer. The tackifier component had a 39:1 ratio of PICCOLYTE A135 to POLYSTER T130. All of the components were added to a glass jar along with toluene to make a solution of approximately 43% solids. The jar was sealed and the contents thoroughly mixed by placing the jar on a roller at about 2-6 rpm for at least 24 hours prior to coating.

Preparation of Adhesive Films

The pressure sensitive adhesive composition above was knife-coated onto a paper liner web having a silicone release surface. The paper liner web speed was 2.75 meter/min. After coating, the web was passed through an oven 11 meters long (residence time 4 minutes total) having three temperature zones. The temperature in zone 1 (2.75 meter) was 57° C.; temperature in zone 2 (2.75 meter) was 71° C.; temperature in zone 3 (about 5.5 meter) was 82° C. The caliper of the dried adhesive was approximately 2.5-3.0 mils thick. Transfer adhesives were then stored at ambient conditions.

Samples of the transfer adhesive were then laminated to one side of the multilayer film backing. The tape samples were die cut into 1″ wide×5″ long strips and 90° Peel Adhesion data was obtained and is shown in Table 3.

TABLE 3
90° Peel Adhesion Strength Test

| | | | Average of |
|---|---|---|---|
| | | | Damage |
| | Average of Actual | Average of Actual | Visual rating |
| Example | Max load (oz/in) | Avg load (oz/in) | (0 to 5) |
| 1 | 49.67 | 25.08 | 5 |
| 2 | 36.98 | 23.81 | 2.5 |
| 3 | 31.19 | 26.55 | 1 |
| 4 | 31.80 | 24.12 | 2 |
| 5 | 24.60 | 19.6 | 0 |
| 6 | 28.54 | 21.8 | 0.5 |
| 7 | 32.78 | 23.8 | 1.5 |
| 8 | 30.00 | 23.2 | 0.5 |
| 13 | 33.21 | 14.00 | 3 |
| 14 | 26.00 | 17.86 | 0 |
| 15 | 15.16 | 10.73 | 0 |
| 16 | 31.12 | 11.61 | 2 |
| 19 | 12.17 | 7.06 | 0 |
| 20 | 12.22 | 8.07 | 0 |
| 21 | 17.87 | 7.80 | 0 |
| 22 | 6.86 | 5.69 | 0 |
| 23 | 9.50 | 6.72 | 0 |
| 24 | 12.90 | 7.24 | 0 |
| Control | 29.16 | 18.46 | 1.5 |

Mechanical property data was also obtained on some of the examples using the Tensile Test procedure described above.

TABLE 4
Mechanical Properties

| | Modulus of | Secant | | | |
|---|---|---|---|---|---|
| | Elasticity | Modulus | Yield Stress | Strain at | P50 |
| Example | (kPa) | (kPa) | (kPa) | Yield (%) | (N/in) |
| 1 | 187000 | 165000 | 4000 | 3.0 | 9.0 |
| 3 | 9000 | 9000 | 550 | 8.0 | 6.5 |
| 4 | 6000 | 6000 | 400 | 9.0 | 10.5 |
| 5 | 8500 | 8500 | 480 | 7.5 | 5.0 |
| 6 | 8500 | 8500 | 500 | 8.0 | 5.5 |
| 7 | 8500 | 8500 | 500 | 8.0 | 4.5 |
| 8 | 8500 | 8500 | 530 | 8.5 | 4.0 |
| 13 | 13500 | 13500 | 880 | 8.5 | 20.5 |
| 14 | 12000 | 12000 | 610 | 7.0 | 5.5 |
| 15 | 7500 | 7500 | 470 | 8.5 | 3.0 |
| 16 | 7500 | 7500 | 500 | 9.5 | 14.5 |
| 17 | 10000 | 10000 | 530 | 8.5 | 4.0 |
| 18 | 500 | 500 | 100 | 20.0 | 3.0 |
| 19 | 7500 | 6800 | 350 | 7.5 | 2.5 |
| 20 | 6900 | 6400 | 550 | 12.0 | 3.4 |
| 21 | 15000 | 14200 | 850 | 8.0 | 5.4 |
| 22 | 2000 | 1700 | 200 | 14.0 | 1.0 |
| 23 | 4400 | 4300 | 240 | 7.5 | 1.6 |
| 24 | 12400 | 12200 | 1000 | 11.0 | 4.2 |

### Examples 25-36

Additional multilayer film constructions that may be useful as backings in the present invention were prepared as described above and are provided in Table 5. The mechanical properties of the films were tested as described above, except that the samples were pulled to a displacement of 600% Strain. The results are provided in Table 6.

TABLE 5
Multilayer Film Constructions

| | | | Core Layer | Skin Layer | Core Layer to | Total Film |
|---|---|---|---|---|---|---|
| | Core Layer | Skin Layer | Thickness | Thickness | Skin Layer | Thickness |
| Example | Material | Material | (μm) | (μm) | Ratio | (μm) |
| 25 | KRATON | OPTEMA | 120 | 10 | 12/1 | 140 |
| | 1114 | TC120 | | | | |
| 26 | KRATON | OPTEMA | 112 | 15 | 7/1 | 142 |
| | 1114 | TC120 | | | | |
| 27 | KRATON | OPTEMA | 109 | 18 | 6/1 | 145 |
| | 1114 | TC120 | | | | |
| 28 | KRATON | OPTEMA | 94 | 14 | 7/1 | 122 |
| | 1114 | TC120 | | | | |
| 29 | KRATON | OPTEMA | 117 | 12 | 10/1 | 141 |
| | 1114 | TC120 | | | | |
| 30 | KRATON | OPTEMA | 90 | 9 | 10/1 | 108 |
| | 1114 | TC120 | | | | |
| 31 | KRATON | PP 3445 | 66 | 6.5 | 10/1 | 79 |
| | 1657 | | | | | |
| 32 | KRATON | ENGAGE | 81 | 8 | 10/1 | 97 |
| | 1657 | 8450 | | | | |
| 33 | KRATON | AFFINITY | 161 | 7 | 23/1 | 175 |
| | 1114 | 1850 | | | | |
| 34 | KRATON | ENGAGE | 88 | 2 | 44/1 | 92 |
| | 1106 | 8200 | | | | |
| 35 | KRATON | VISTAMAXX | 136 | 3 | 45/1 | 142 |
| | 1114 | 3980 | | | | |
| 36 | KRATON | AFFINITY | 109 | 8 | 14/1 | 125 |
| | 1114 | 1850 | | | | |
| | POLYSTER | | | | | |
| | T160 (70 PPH) | | | | | |

TABLE 6
Mechanical Properties

| | Modulus of | | Strain at | | Non- |
|---|---|---|---|---|---|
| | Elasticity | Yield Stress | Yield | P50 | recoverable |
| Example | (kPa) | (kPa) | (%) | (N/in) | Strain (%) |
| 25 | 6700 | 520 | 11 | 3.52 | 9.8 |
| 26 | 13300 | 800 | 8 | 5.2 | 16.7 |
| 27 | 15000 | 900 | 8.5 | 6.04 | 18.9 |
| 28 | 17500 | 1000 | 7.5 | 5.2 | 18.9 |
| 29 | 6000 | 500 | 11 | 2.97 | 10.7 |
| 30 | 6250 | 400 | 9 | 2.22 | 10.2 |
| 31 | 115000 | 2400 | 4.5 | 4.86 | 15.5 |
| 32 | 18000 | 1100 | 8 | 5.03 | 15.1 |
| 33 | 8300 | 520 | 9 | 4.12 | 6.6 |
| 34 | 2200 | 190 | 12 | 1.29 | 5.8 |
| 35 | 6250 | 330 | 7 | 2.53 | 5.1 |
| 36 | 4300 | 240 | 7.5 | 1.67 | 13.5 |

Reference throughout this specification to “one embodiment,” “some embodiments,” “one or more embodiments” or “an embodiment,” whether or not including the term “exemplary” preceding the term “embodiment,” means that a particular feature, structure, material, or characteristic described in connection with the embodiment is included in at least one embodiment of the certain exemplary embodiments of the present disclosure. Thus, the appearances of the phrases such as “in one or more embodiments,” “in certain embodiments,” “in one embodiment” or “in an embodiment” in various places throughout this specification are not necessarily referring to the same embodiment of the certain exemplary embodiments of the present disclosure. Furthermore, the particular features, structures, materials, or characteristics may be combined in any suitable manner in one or more embodiments.

The recitation of all numerical ranges by endpoint is meant to include all numbers subsumed within the range (i.e., the range 1 to 10 includes, for example, 1, 1.5, 3.33, and 10).

The terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

Moreover, the terms top, bottom, over, under and the like in the description and the claims are used for descriptive purposes and not necessarily for describing relative positions. It is to be understood that the terms so used are interchangeable under appropriate circumstances and that the embodiments of the invention described herein are capable of operation in other orientations than described or illustrated herein.

All references mentioned herein are hereby incorporated by reference in their entirety.

With reference to the Figures, like numerals are used to designate like components throughout the set of Figures.

Those having skill in the art will appreciate that many changes may be made to the details of the above-described embodiments and implementations without departing from the underlying principles thereof. Further, various modifications and alterations of the present invention will become apparent to those skilled in the art without departing from the spirit and scope of the invention. The scope of the present application should, therefore, be determined only by the following claims and equivalents thereof.

What is claimed is:

1. An adhesive article, comprising:
a multilayer backing comprising:
a core layer comprising at least one of an elastomeric material, an elastomeric polymer, SEBS, SEPS, SIS, SBS, polyurethane, ethyl vinylacetate (EVA), ethyl methyl acrylate (EMA) ultra low linear density polyethylene (ULLDPE), hydrogenated polypropylene, and combinations or blends thereof;
a first skin layer comprising at least one of polypropylene, polyethylene, high density polyethylene (HDPE), low density polyethylene (LDPE), linear low density polyethylene (LLDPE), a polyurethane, EVA, EMA, an adhesive, and combinations or blends thereof; and
a peelable adhesive adjacent to a major surface of the multilayer backing;
wherein the backing has a core to skin ratio of between about 2:1 and about 100:1; and
wherein the backing has a modulus of elasticity and/or a modulus of secant of between about 100 psi and about 18,000 psi as determined by at least one of ASTM D638-14 and ASTM D412-06a.

2. The adhesive article of claim 1, further comprising:
a second skin layer comprising at least one of polypropylene, polyethylene, high density polyethylene (HDPE), low density polyethylene (LDPE), linear low density polyethylene (LLDPE), a polyurethane, EVA, and combinations or blends thereof.

3. The adhesive article of claim 1, wherein the backing has a thickness of between about 2 mils and about 40 mils.

4. The adhesive article of claim 1, wherein a force of between about 1N and about 50N per inch width results in at 10% strain in tensile elongation as measured according to ASTM D638-14 and/or ASTM D412-06a.

5. The adhesive article of claim 1, wherein the core has a tensile and/or elastic modulus of between about 50 psi and about 5000 psi as measured according to ASTM D638.

6. The adhesive article of claim 1, wherein at least one of the first or second skin layer has an elastic and/or secant modulus of between about 3000 psi and about 300,000 psi as measured according to ASTM D638.

7. The adhesive article of claim 1, wherein the core comprises at least one of SEBS, SIS, or SBS.

8. The adhesive article of claim 1, wherein the core and/or first or second skin layer further including at least one of a tackifier, a plasticizer, a plasticizing oil, a UV inhibitor, and/or an antioxidant.

9. The adhesive article of claim 1, wherein the first skin comprises at least one of polypropylene or polyethylene; and
wherein the second skin comprises at least one of polypropylene or polyethylene.

10. The adhesive article of claim 1, wherein the peelable adhesive includes at least one of SBS, SBR, SIS, SEBS, acrylate, and/or polyurethane.

11. The adhesive article of claim 1, wherein the peelable adhesive includes at least one of the following tackifiers: polyterpene, terpene phenol, rosin esters, hydrocarbons, C5 resins, C9 resins, and/or rosin acids.

12. The adhesive article of claim 1, wherein the peelable adhesive includes at least one of an acrylate, a polyurethane, a tackified rubber adhesives, such as natural rubber; olefins; silicones, such as silicone polyureas; synthetic rubber adhesives such as polyisoprene, polybutadiene, and styrene-isoprene-styrene, styrene-ethylene-butylene-styrene and styrene-butadiene-styrene block copolymers, SBR, SEBS, and other synthetic elastomers; and tackified or untackified acrylic adhesives such as copolymers of isooctylacrylate and acrylic acid, which can be polymerized by radiation, solution, suspension, or emulsion techniques; polyurethanes; silicone block copolymers; and combinations thereof.

13. The adhesive article of claim 1, wherein the peelable adhesive has a Tg of between about −80 degrees Celsius and about 20 degrees Celsius.

14. The adhesive article of claim 1, wherein the multilayer backing is optically clear.

15. The adhesive article of claim 1, wherein the core comprises a polyethylene polypropylene copolymer.

16. The adhesive article of claim 1, wherein the wherein the backing has a modulus of elasticity and/or a modulus of secant of between about 1000 psi and about 15,000 psi as determined by at least one of ASTM D638-14 and ASTM D412-06a.

17. An adhesive article, comprising:
a backing comprising a core layer comprising at least one of an elastomeric material, an elastomeric polymer, SEBS, SEPS, SIS, SBS, polyurethane, ethyl vinylacetate (EVA), ethyl methyl acrylate (EMA) ultra low linear density polyethylene (ULLDPE), hydrogenated polypropylene, and combinations or blends thereof;
and a peelable adhesive adjacent to a major surface of the backing,
wherein the backing has a modulus of elasticity and/or a modulus of secant of between about 100 psi and about 18,000 psi as determined by at least one of ASTM D638-14 and ASTM D412-06a.

18. The adhesive article of claim 17, wherein the backing has a modulus of elasticity and/or a modulus of secant of between about 1000 psi and about 15,000 psi as determined by at least one of ASTM D638-14 and ASTM D412-06a.
